(19) United States
(12) Patent Application Publication
(10) Pub. No.: US 2026/0234176 A1
(43) Pub. Date: Aug. 13, 2026

(54) CURABLE PHOSPHORUS-CONTAINING COMPOUNDS AND PREPARATION METHOD THEREFOR

(71) Applicant: UFC CORPORATION, Taipei City (TW)

(72) Inventors: Jen-Hai LIAO, Taipei City (TW); Cheng-Fang CHIANG, Taipei City (TW)

(73) Assignee: UFC CORPORATION, Taipei City (TW)

(21) Appl. No.: 19/432,404

(22) Filed: Dec. 24, 2025

(30) Foreign Application Priority Data
Feb. 12, 2025 (TW) 114105201

(51) Int. Cl. C07F 9/6574

(52) U.S. Cl. CPC C07F 9/65744

(57) ABSTRACT

Provided are a series of novel curable phosphorus-containing compounds having a bis(6H-dibenzo[c,e][1,2]oxaphosphinine-6-oxide) structure and the preparation methods thereof. The curable phosphorus-containing compounds can cross-link with other vinyl-containing monomers by the unique design of dual reactive ends thereon, and thus can be used as reactive halogen-free flame retardants. The novel phosphorus-containing compounds are represented by the General Formula (1).

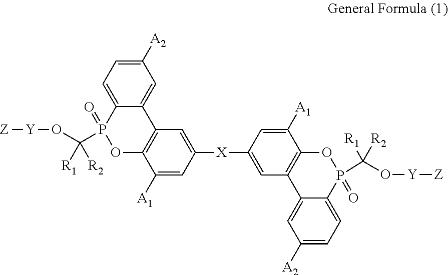

### BACKGROUND

### 1. Technical Field

The present disclosure provides a series of curable phosphorus-containing compounds having bis(6H-dibenzo[c,e][1,2]oxaphosphinine-6-oxide) structures, which are represented by General Formula (1),

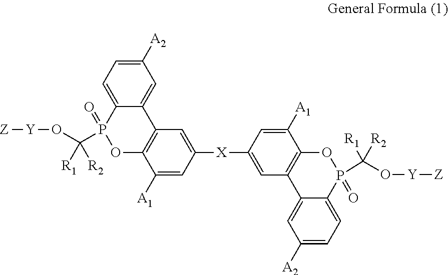

### 2. Description of Associated Art

9,10-dihydro-9-oxa-10-phosphaphenanthrene-10-oxide (DOPO) has been broadly applied in uses including antibacterial agents, antioxidants, fade resistant agents, and flame retardants for a long time. DOPO, a halogen-free phosphorus-based flame retardant, with a special planar structure is beneficial to increase the flame-retarding performance. Because of the increasing awareness of environmental protection, halogen-free flame retardants have boomed in the past decade and have gradually replaced halogen-containing flame retardants in response to the increasingly strict environmental protection requirements in various countries. The advantages of switching to halogen-free flame retardants include reduction of highly hazardous corrosive gas and highly toxic compounds generated during combustion of halogen-containing flame retardants, which cause severe environmental harm. In addition to protecting the surface of a chemical article and insulating it from external oxygen gas and heat through a condensed-phase flame-retardant mechanism, phosphorus-containing flame retardants can capture and stabilize the high-energy free radicals generated during combustion through a free radical capture mechanism, thereby achieving flame-retarding effect.

However, in order to achieve a certain effect, the phosphorus-based flame retardant is generally added in an amount greater than 10% w/w. When added in such a high amount, the added flame retardant may cause compatibility issues either after production of a final product or during subsequent processing, ranging from relatively mild problems, such as migration of the flame retardant to the surface of the final product, to more serious problems, such as blooming.

To solve the problems aforementioned, the compatibility between the added phosphorus-based flame retardant and the base material must be improved. One approach is to increase the molecular weight of DOPO derivatives, since materials used in manufacturing are generally high-molecular-weights compounds. Another approach is to derivatize DOPO to obtain a structure having reactive ends, thereby the result compound can be used as a reactive flame retardant. By cross-linking the reactive ends of the reactive flame retardant with other reactive groups, flame-retarding moieties can be thus bonded to the substrate, which can also solve the aforementioned problems of additive flame retardants.

### SUMMARY

To achieve the above-mentioned objectives, the present disclosure provides a novel curable phosphorus-containing compound having bis(6H-dibenzo[c,e][1,2]oxaphosphinine-6-oxide) structure represented by General Formula (1). This novel curable compound employs a dual-reactive-end design that not only roughly doubles its molecular weight to improve its compatibility with the base material but also allows the reactive ends to cross-link with other cross-linkable monomers or oligomeric resins to further increase the molecular weight of the polymer. Moreover, compared to a structure bearing only a single reactive end, the dual-end design offers the additional benefit of enhanced adhesion.

The curable phosphorus-containing compound of the present disclosure is represented by General Formula (1),

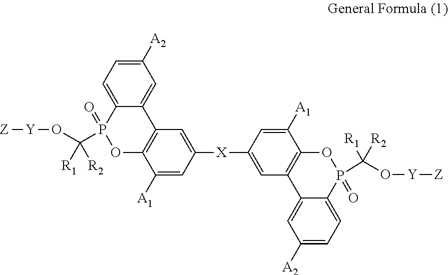

wherein,
A₁ and A₂ are each independently selected from the group consisting of hydrogen atom, hydroxy (—OH), cyano (—CN), halo, alkoxy (—OR), alkyl with the carbon number between 1-8, cycloalkyl with a carbon number between 3-8, aryl, heteroaryl and arylalkyl;
R₁ and R₂ are each independently selected from the group consisting of hydrogen atom, alkyl with a carbon number between 1-8, cycloalkyl with a carbon number between 3-8, aryl, heteroaryl and arylalkyl;
X represents single bond, (CH₂)n, CR₃R₄, C═O, or SO₂, wherein R₃ and R₄ are respectively selected from the group consisting of hydrogen atom, fluorine atom, fluorine-containing alkyl, alkyl with a carbon number between 1-8, cycloalkyl with a carbon number between 3-8, aryl, heteroalkyl, and arylalkyl, n is an integer of 1-12;
each Y represents

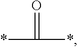

wherein * represents a bonding position; and
each Z independently represents

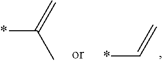

wherein * represents a bonding position.

In an embodiment, the curable phosphorus-containing compound of the present disclosure is selected from one of the following:

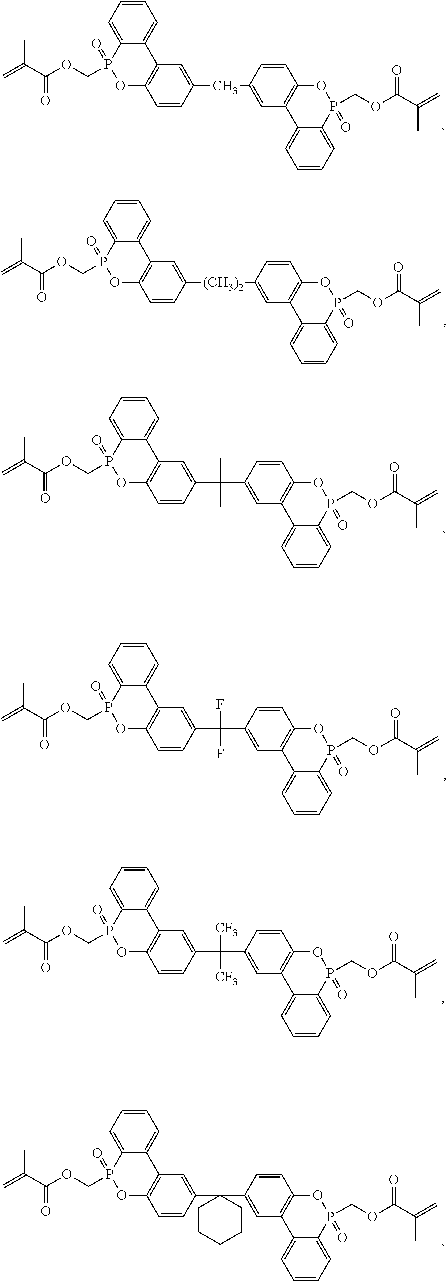

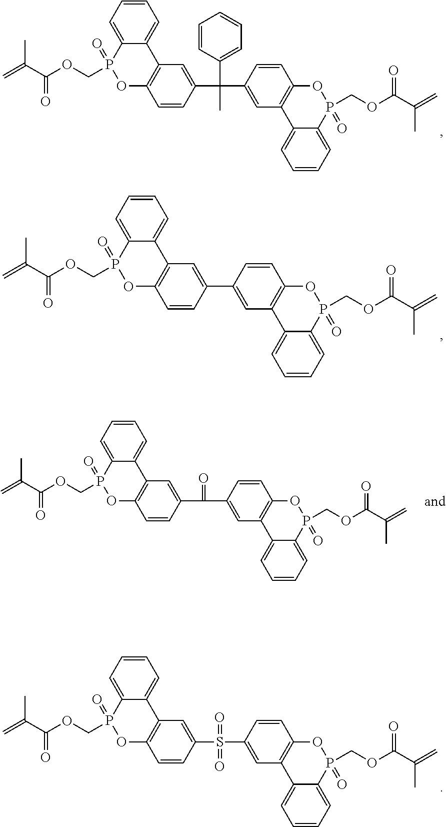

In an embodiment, the curable phosphorus-containing compound of the present disclosure is selected from one of the following:

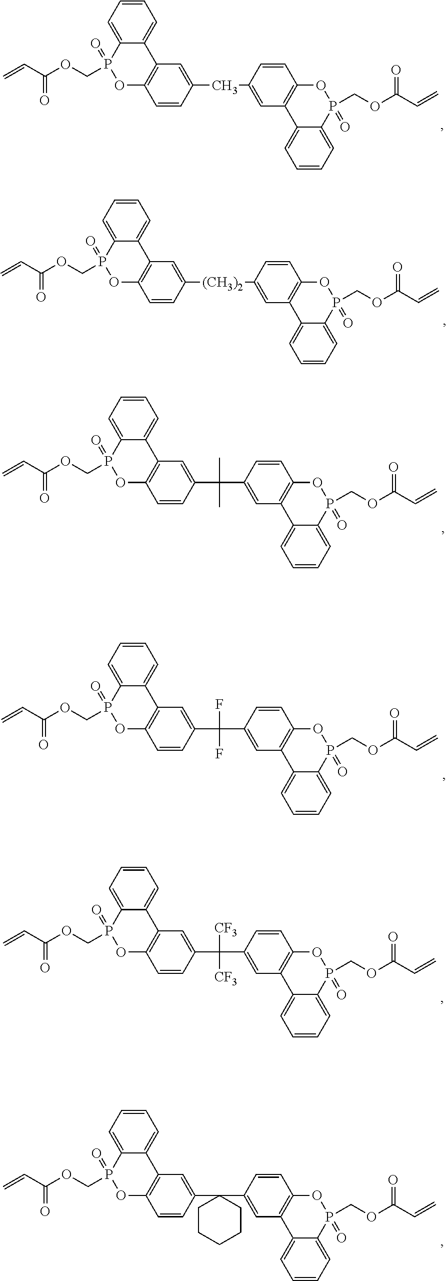

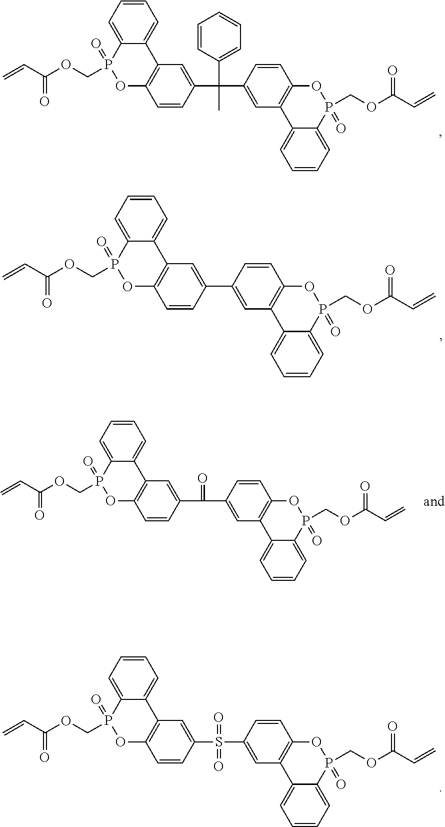

The present disclosure also provides a preparation method of the curable phosphorus-containing compound having bis(6H-dibenzo[c,e][1,2]oxaphosphinine-6-oxide) structure represented by General Formula (1), comprising:
(1) performing a nucleophilic addition reaction of bis(6H-dibenzo[c,e][1,2]oxaphosphinine-6-oxide) with an aldehyde or ketone compound in a presence of a solvent to obtain a diol intermediate; and
(2) performing an esterification reaction of the diol intermediate with an acylating reagent, and a solvent, and optionally a catalyst or an acid neutralizer,
wherein the steps (1) and (2) above are represented by the following reaction scheme:

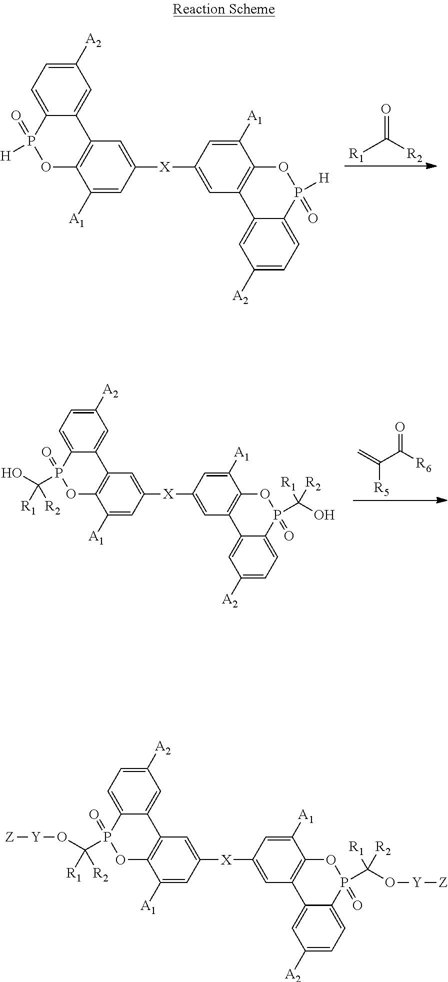

wherein,
A₁ and A₂ are each independently selected from the group consisting of hydrogen atom, hydroxy, cyano, halo, alkoxy, alkyl with a carbon number between 1-8, cycloalkyl with a carbon number between 3-8, aryl, heteroaryl and arylalkyl;
R₁ and R₂ are each independently selected from the group consisting of hydrogen atom, alkyl with a carbon number between 1-8, cycloalkyl with a carbon number between 3-8, aryl, heteroaryl and arylalkyl;
X represents a single bond, (CH₂)ₙ, CR₃R₄, C═O, or SO₂, wherein R₃ and R₄ are respectively selected from the group consisting of hydrogen atom, fluorine atom, fluorine-containing alkyl, alkyl with a carbon number between 1-8, cycloalkyl with a carbon number between 3-8, aryl, heteroalkyl, and arylalkyl, n is an integer of 1-12;
each Y independently represents

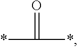

wherein * represents a bonding position;
each Z independently represents

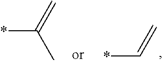

wherein * represents a bonding position;
R₅ represents hydrogen atom or methyl; and
R₆ represents chlorine atom, acryloxy, or methacryloxy.

In an embodiment, in the nucleophilic addition reaction of step (1), an equivalence ratio of the bis(6H-dibenzo[c,e][1,2]oxaphosphinine-6-oxide) to the aldehyde or ketone compound is about 1:2 to about 1:10.

In an embodiment, the nucleophilic addition reaction of step (1) is performed with a mixture comprising the bis(6H-dibenzo[c,e][1,2]oxaphosphinine-6-oxide), the aldehyde or ketone compound, and the solvent at about 20° C. to about 200° C.

In one embodiment, the solvent used in the nucleophilic addition reaction of step (1) is selected from the group consisting of dichloromethane, chloroform, carbon tetrachloride, 1,2-dichloroethane, ethyl acetate, butyl acetate, toluene, xylene, mesitylene, chlorobenzene, dichlorobenzene, trichlorobenzene, N,N′-dimethylformamide (DMF), N,N′-dimethylacetamide (DMAC), N-methylpyrrolidone, dimethyl sulfoxide (DMSO), and a combination thereof.

In an embodiment, in the nucleophilic addition reaction of step (1), a weight ratio of the solvent to the bis(6H-dibenzo[c,e][1,2]oxaphosphinine-6-oxide) is 1:0.1 to 1:20.

In one embodiment, in the esterification reaction of step (2), an equivalence ratio of the diol intermediate to the acylating reagent is about 1:2 to about 1:10.

In one embodiment, the esterification reaction of step (2) is performed with a mixture comprising the diol intermediate and the acylating reagent, and the solvent, and optionally the catalyst or the acid-neutralizing agent at about −20° C. to about 150° C.

In an embodiment, the catalyst or the acid-neutralizing agent used in the esterification reaction of step (2) is selected from the group consisting of lithium hydroxide, sodium hydroxide, potassium hydroxide, magnesium hydroxide, calcium hydroxide, lithium carbonate, lithium bicarbonate, sodium carbonate, sodium bicarbonate, potassium carbonate, potassium bicarbonate, ammonia, dimethylamine, diethylamine, di-n-propylamine, di-isopropylamine, di-n-butylamine, di-isobutylamine, triethylamine, tri-n-propylamine, tri-n-butylamine, 1,4-diazabicyclo[2.2.2]octane (DABCO), pyridine, 2-methylpyridine, 4-methylpyridine, 2,6-dimethylpyridine, 4-N,N′-dimethylpyridine (DMAP), and a combination thereof.

In an embodiment, in the esterification reaction of step (2), the catalyst or the acid-neutralizing agent may be absent; if present, a weight ratio of the catalyst or the acid-neutralizing agent to the diol intermediate is 0:0.1 to 5:1.

In an embodiment, a weight ratio of the solvent to the bis(6H-dibenzo[c,e][1,2]oxaphosphinine-6-oxide) is 1:0.1 to 1:20.

### BRIEF DESCRIPTION OF THE DRAWINGS

FIG. 1 is a H-NMR spectrum of the curable phosphorus-containing compound of Example 1 of the present disclosure.

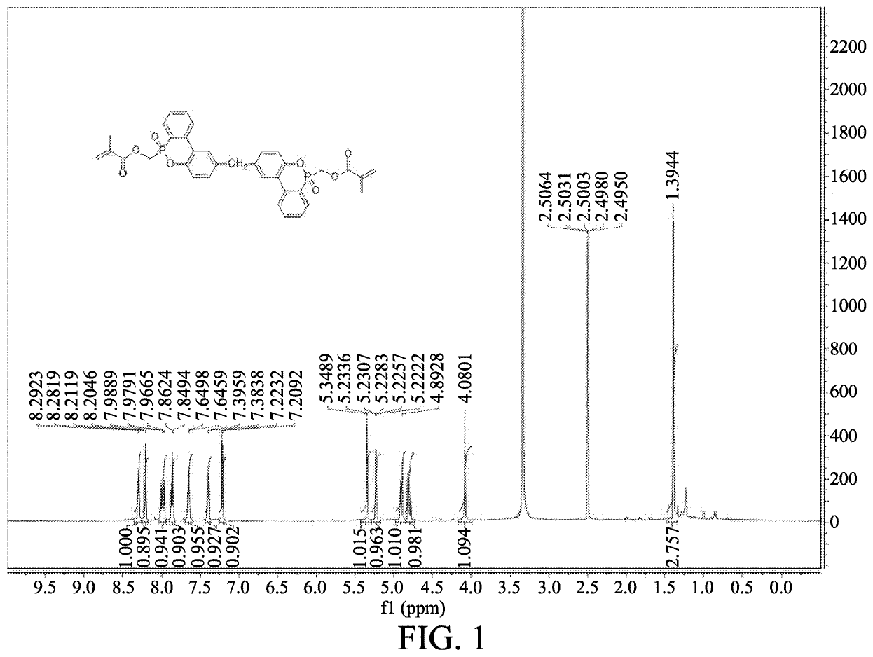

FIG. 2 is a H-NMR spectrum of the curable phosphorus-containing compound of Example 2 of the present disclosure.

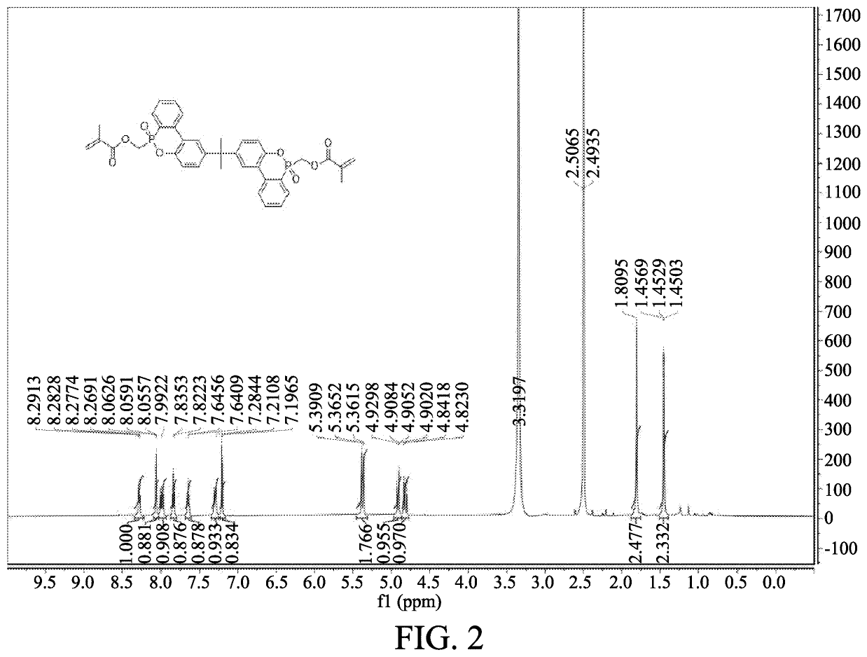

FIG. 3 is a FT-IR spectrum of the curable phosphorus-containing compound of Example 2 of the present disclosure.

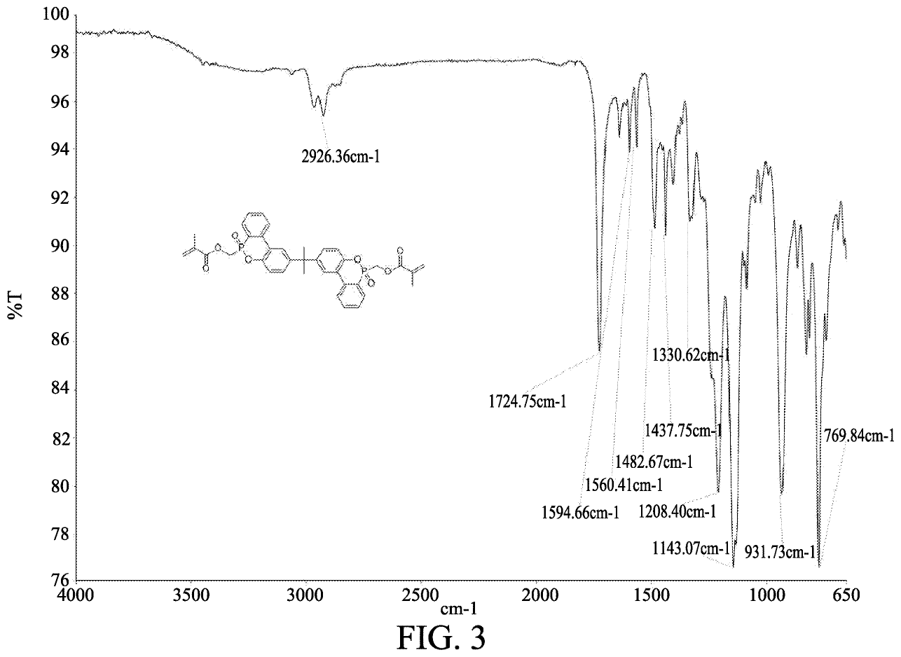

### DETAILED DESCRIPTION

The execution modes of the present disclosure will be illustrated by following specific embodiments, anyone skilled in the art can easily realize the advantages and effects of the present disclosure based on the content described in the description. The present disclosure also can be performed or applied by other different execution modes, and the details of the present disclosure each can be imparted with different modifications and alterations based on different views and applications without departing from the scope described by the present disclosure.

The present disclosure provides the curable phosphorus-containing compound represented by General Formula (1),

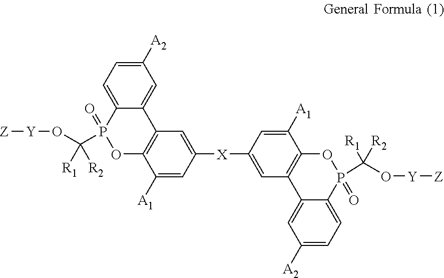

wherein,
A₁ and A₂ are each independently selected from the group consisting of hydrogen atom, hydroxy (—OH), cyano (—CN), halo, alkoxy (—OR), alkyl with the carbon number between 1-8, cycloalkyl with the carbon number between 3-8, aryl, heteroaryl and arylalkyl;
R₁ and R₂ are each independently selected from the group consisting of hydrogen atom, alkyl with the carbon number between 1-8, cycloalkyl with the carbon number between 3-8, aryl, heteroaryl and arylalkyl;
X represents single bond, (CH₂)ₙ, CR₃R₄, C═O, or SO₂, wherein R₃ and R₄ are respectively selected from the group consisting of hydrogen atom, fluorine atom, fluorine-containing alkyl, alkyl with the carbon number between 1-8, cycloalkyl with the carbon number between 3-8, aryl, heteroalkyl, and arylalkyl, n is an integer of 1-12;
each Y independently represents

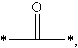

wherein * represents the bonding position; and
each Z independently represents

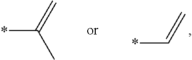

wherein * represented the bonding position.

In an embodiment, in the General Formula (1), each of A₁, A₂, R₁, R₂ is hydrogen atom, X is CH₂, Y is

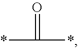

### and Z is

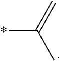

For example, the compound represented by the General Formula (1) of the present disclosure has a structure of Formula (A-1) below:

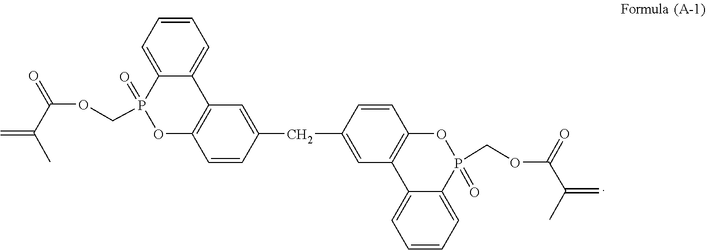

In an embodiment, in the General Formula (1), each of A₁, A₂, R₁, R₂ is hydrogen atom, X is C(CH₃)₂, Y is

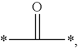

### and Z is

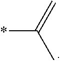

For example, the compound represented by the General Formula (1) of the present disclosure has the structure of Formula (A-2) below:

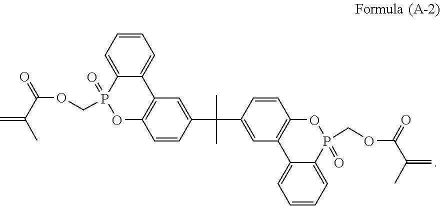

In an embodiment, in the General Formula (1), each of A₁, A₂, R₁, R₂ is hydrogen atom, X is C—(CH₂)₅, Y is

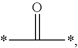

### and Z is

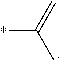

For example, the compound represented by the General Formula (1) of the present disclosure has the structure of Formula (A-3) below:

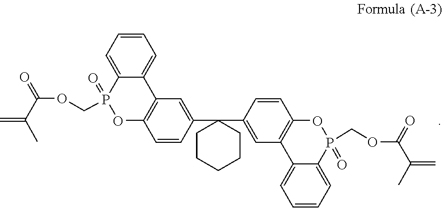

In an embodiment, in the General Formula (1), each of A₁, A₂, R₁, R₂ is hydrogen atom, X is SO₂, Y is

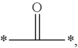

### and Z is

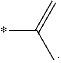

For example, the compound represented by the General Formula (1) of the present disclosure has the structure of Formula (A-4) below:

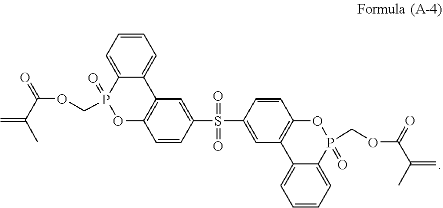

In an embodiment, in the General Formula (1), each of A₁, A₂, R₁, R₂ is hydrogen atom, X is a single bond, Y is

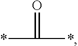

### and Z is

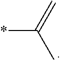 [SMILES: *C(=C)C]

For example, the compound represented by the General Formula (1) of the present disclosure has the structure of Formula (A-5) below:

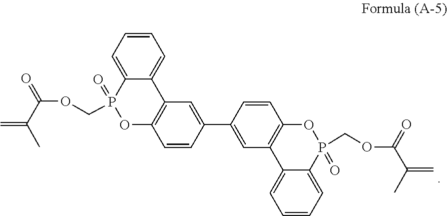

The present disclosure further provides the preparation method of the novel curable phosphorus-containing compound having bis(6H-dibenzo[c,e][1,2]oxaphosphinine-6-oxide) structure, comprising: (1) performing in a first step of the nucleophilic addition reaction of bis(6H-dibenzo[c,e][1,2]oxaphosphinine-6-oxide) with an aldehyde or ketone compound in the presence of a solvent to afford an diol intermediate; and (2) performing a second step of the esterification reaction of the diol intermediate with an acylating reagent, and a solvent, and optionally a catalyst or an acid-neutralizing agent, wherein the steps (1) and (2) above are represented by the following reaction scheme:

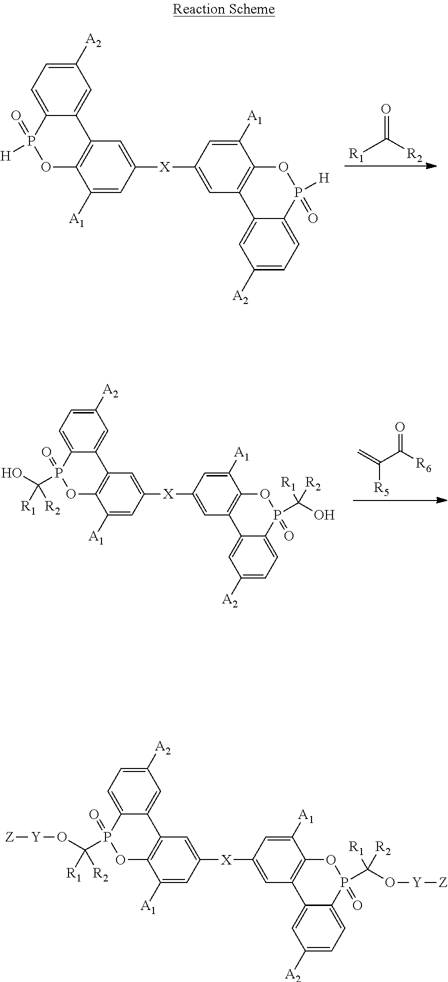

wherein,
A₁ and A₂ are each independently selected from the group consisting of hydrogen atom, hydroxy (—OH), cyano (—CN), halo, alkoxy (—OR), alkyl with the carbon number between 1-8, cycloalkyl with the carbon number between 3-8, aryl, heteroaryl and arylalkyl;
R₁ and R₂ are each independently selected from the group consisting of hydrogen atom, alkyl with the carbon number between 1-8, cycloalkyl with the carbon number between 3-8, aryl, heteroaryl and arylalkyl;
X represents single bond, (CH₂)ₙ, CR₃R₄, C═O, or SO₂, wherein R₃ and R₄ are respectively selected from the group consisting of hydrogen atom, fluorine atom, fluorine-containing alkyl, alkyl with the carbon number between 1-8, cycloalkyl with the carbon number between 3-8, aryl, heteroalkyl, and arylalkyl;
each Y independently represents

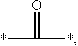

wherein * represents the bonding position;
each Z independently represents or

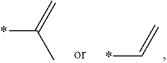

wherein * represents the bonding position;
R₅ represents hydrogen atom or methyl; and
R₆ represents chlorine atom, acryloxy, or methacryloxy.

In an embodiment, each of A₁ and A₂ is hydrogen atom and each of R₁ and R₂ is hydrogen atom.

In an embodiment, in the nucleophilic addition reaction of step (1), the equivalence ratio of the bis(6H-dibenzo[c,e][1,2]oxaphosphinine-6-oxide) to the aldehyde or ketone compound is about 1:2 to about 1:10.

In an embodiment, in the nucleophilic addition reaction of step (1), the mixture comprising bis(6H-dibenzo[c,e][1,2]oxaphosphinine-6-oxide) with an aldehyde or ketone compound reacts at a temperature from about 20° C. to about 200° C.

In an embodiment, in the nucleophilic addition reaction of step (1), the weight ratio of the solvent to the bis(6H-dibenzo[c,e][1,2]oxaphosphinine-6-oxide) is 1:0.1 to 1:20.

In an embodiment, in the nucleophilic addition reaction of step (1), the solvent is an organic solvent.

In an embodiment, in the nucleophilic addition reaction of step (1), the solvent is preferably an aprotic solvent.

In an embodiment, the aprotic solvent of step (1) is selected from dichloromethane, chloroform, carbon tetrachloride, 1,2-dichloroethane, ethyl acetate, butyl acetate, toluene, xylene, mesitylene, chlorobenzene, dichlorobenzene, trichlorobenzene, tetrahydrofuran, acetonitrile, N,N′-dimethylformamide, N,N′-dimethylacetamide, 1-methyl-2-pyrrolidone, dimethyl sulfoxide, and a combination thereof.

In an embodiment, in the esterification reaction of step (2), the equivalence ratio of the diol intermediate to the acylating reagent is about 1:2 to about 1:20.

In an embodiment, in the esterification reaction of step (2), the mixture comprising the diol intermediate and the acylating reagent reacts at a temperature which is about −20° C. to about 150° C.

In an embodiment, in the esterification reaction of step (2), the weight ratio of the diol intermediate to the solvent is 1:0.1 to 1:20.

In an embodiment, in the esterification reaction of step (2), the solvent is an organic solvent.

In an embodiment, in the esterification reaction of step (2), the solvent is preferably an aprotic solvent.

In an embodiment, the aprotic solvent of step (2) is selected from dichloromethane, chloroform, carbon tetrachloride, 1,2-dichloroethane, ethyl acetate, butyl acetate, toluene, xylene, mesitylene, chlorobenzene, dichlorobenzene, trichlorobenzene, tetrahydrofuran, acetonitrile, N,N′-dimethylformamide, N,N′-dimethylacetamide, 1-methyl-2-pyrrolidone, dimethyl sulfoxide, and a combination thereof.

In an embodiment, in the esterification reaction of step (2), the catalyst or the acid-neutralizing agent may be absent; if present, the weight ratio of the catalyst (or the acid-neutralizing agent) to the diol intermediate is 0:0.1 to 5:1,

In an embodiment, in the esterification reaction of step (2), the catalyst (or the acid-neutralizing agent) is an inorganic base, an organic base, or both.

In an embodiment, in the esterification reaction of step (2), preferably, the inorganic base compound is selected from the group consisting of lithium hydroxide, sodium hydroxide, potassium hydroxide, magnesium hydroxide, calcium hydroxide, lithium carbonate, lithium hydrogen carbonate, sodium carbonate, sodium hydrogen carbonate, potassium carbonate, potassium hydrogen carbonate.

In an embodiment, in the esterification reaction of step (2), preferably, the organic base compound is selected from the group consisting of ammonia, dimethylamine, diethylamine, di-n-propylamine, di-iso-propylamine, di-n-butylamine, di-iso-butylamine, triethylamine, tri-n-propylamine, tri-n-buylamine, 1,4-diazabicyclo[2.2.2]octane (DABCO), pyridine, 2-methylpyridine, 4-methylpyridine, 2,6-dimethylpyridine, 4-N,N′-dimethylpyridine (DMAP).

### Example 1

### Synthesis of (methylenebis(6-oxidodibenzo[c,e][1,2]oxaphosphinine-2,6-diyl))bis(methylene)bis(2-methylacrylate) (DI-DOPO-ME-MA, A1)

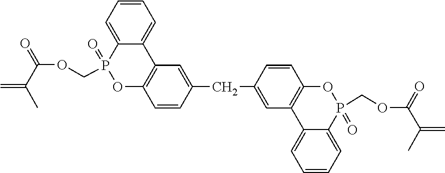 [SMILES: C=C(C)C(=O)OCP1(=O)Oc2ccc(Cc3ccc4c(c3)-c3ccccc3P(=O)(COC(=O)C(=C)C)O4)cc2-c2ccccc21]

40 g of 2,2′-methylene-bis(6H-dibenzo[c,e][1,2]oxaphosphinine-6-oxide), 160 g of DMAC, and 6 g of polyformaldehyde were mixed in a reaction flask and heated to 70° C.-80° C. and were reacted for 20 hours. After completion of reaction, 160 g of water was added dropwise slowly, and the resulting solid was collected by filtration after cooling to room temperature, washed with water twice and then dried in vacuum, to afford 40 g of crude diol intermediate DI-DOPO-ME-FA as an off-white solid, which was subjected to the esterification in the next step without further purification.

40 g of the crude diol intermediate, 1.0 g of DMAP, 0.08 g of polymerization inhibitor hydroquinone (HQ), and 40 g of DMF were mixed in a reaction flask and heated to 80° C.-90° C., 30.6 g of methacrylic anhydride was added dropwise slowly, and after the addition is complete, the reaction was performed while maintaining the temperature for 8 hours. Thereafter, the mixture was cooled to room temperature, DMF was recovered under reduced pressure, then the reaction mixture was diluted with 200 g of ethyl acetate, and the organic layer was washed with 5% aqueous sodium bicarbonate solution several times. The organic layer was separated, and the solvent was removed at reduced pressure to obtain 39.2 g of product as an off-white solid with about 68% yield for two steps. The analytical sample was obtained by using column chromatography with a melting point of 103° C.-105° C.

¹H-NMR (DMSO-d₆, 600 MHz) δ: 1.39 (6H, s), 4.08 (2H, s), 4.80 (2H, dd), 4.90 (2H, d), 5.23 (2H, m), 5.35 (2H, s), 7.22 (2H, d, J=8.40 Hz), 7.40 (2H, t), 7.65 (2H, td), 7.86 (2H, t), 7.98 (2H, dd), 8.21 (2H, d, J=4.38 Hz), 8.29 (2H, t) ppm

³¹P-NMR (DMSO-d₆, 243 MHz) δ: 28.70 (s) ppm

### Example 2

### Synthesis of (propane-2,2-diylbis(6-oxidodibenzo[c,e][1,2]oxaphosphinine-2,6-diyl))bis(methylene) bis(2-methylacrylate) (DI-DOPO-DM-MA, A2)

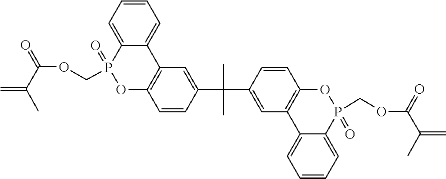 [SMILES: C=C(C)C(=O)OCP1(=O)Oc2ccc(C(C)(C)c3ccc4c(c3)-c3ccccc3P(=O)(COC(=O)C(=C)C)O4)cc2-c2ccccc21]

21.7 g of 2,2′-propane-bis(6H-dibenzo[c,e][1,2]oxaphosphinine-6-oxide), 80 g of DMAC, and 3 g of polyformaldehyde were mixed in a reaction flask and heated to 70° C.-80° C. and were reacted for 20 hours. After completion of reaction, 80 g of water was added dropwise slowly, and the resulting solid was collected by filtration after cooling to room temperature, washed with water twice and then dried in vacuum, to afford 21 g of crude diol intermediate DI-DOPO-DM-FA as an off-white solid, which was subjected to the esterification in the next step without further purification.

21 g of the crude diol intermediate, 0.5 g of DMAP, 0.04 g of polymerization inhibitor HQ, and 21 g of DMF were mixed in a reaction flask and heated to 80° C.-90° C., 15.2 g of methacrylic anhydride was added dropwise slowly, and after the addition is complete, the reaction was performed while maintaining the temperature for 8 hours. Thereafter, the mixture was cooled to room temperature, DMF was recovered under reduced pressure, then the reaction mixture was diluted with 105 g of ethyl acetate, and the organic layer was washed with 5% aqueous sodium bicarbonate solution several times. The organic layer was separated, and the solvent was removed at reduced pressure to obtain 18.9 g of product as an off-white solid with about 65% yield for two steps. The analytical sample was obtained by using column chromatography with a melting point of 92° C.-95° C.

¹H-NMR (DMSO-d₆, 600 MHz) δ: 1.45 (6H, s), 1.81 (6H, s), 4.82 (2H, dd), 4.92 (2H, d), 5.36 (2H, s), 5.39 (2H, s), 7.20 (2H, d, J=8.58 Hz), 7.29 (2H, m), 7.64 (2H, td, J=7.62, 2.88 Hz), 7.84 (2H, t, J=7.86 Hz), 7.99 (2H, dd), 8.06 (2H, t, J=2.1 Hz), 8.29 (2H, dd, J=8.34, 5.1 Hz) ppm

³¹P-NMR (DMSO-d₆, 243 MHz) δ: 28.86 (s) ppm

### Example 3

### Synthesis of (cyclohexane-1,1-diylbis(6-oxidodibenzo[c,e][1,2]oxaphosphinine-2,6-diyl))bis(methylene)bis(2-methylacrylate) (DI-DOPO-CH-MA, A3)

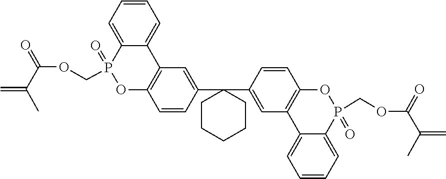 [SMILES: C=C(C)C(=O)OCP1(=O)Oc2ccc(C3(c4ccc5c(c4)-c4ccccc4P(=O)(COC(=O)C(=C)C)O5)CCCCC3)cc2-c2ccccc21]

23.1 g of 2,2′-cyclohexane-1,1′-diylbis(6H-dibenzo[c,e][1,2]oxaphosphinine-6-oxide), 80 g of DMAC, and 3 g of polyformaldehyde were mixed in a reaction flask and heated to 70° C.-80° C. and were reacted for 20 hours. After completion of reaction, 80 g of water was added dropwise slowly, and the resulting solid was collected by filtration after cooling to room temperature, washed with water twice and then dried in vacuum, to afford 22 g of crude diol intermediate DI-DOPO—CH-FA an off-white solid, which was subjected to the esterification in the next step without further purification.

22 g of the crude diol intermediate, 0.48 g of DMAP, 0.039 g of polymerization inhibitor HQ, and 22 g of DMF were mixed in a reaction flask and heated to 80° C.-90° C., 14.8 g of methacrylic anhydride was added dropwise slowly, and after the addition is complete, the reaction was performed while maintaining the temperature for 8 hours. Thereafter, the mixture was cooled to room temperature, DMF was recovered under reduced pressure, then the reaction mixture was diluted with 110 g of ethyl acetate, and the organic layer was washed with 5% aqueous sodium bicarbonate solution several times. The organic layer was separated, and the solvent was removed at reduced pressure to obtain 19.0 g of product as an off-white solid. The two-step yield was about 59.5%, and the product was subjected to separation by column chromatography to afford a sample of analytical grade.

¹H-NMR (DMSO-d₆, 600 MHz) δ: 1.36 (3H, s), 1.37 (3H, s), 1.40~1.60 (6H, m), 2.40~2.60 (4H, m), 4.79 (2H, dd), 4.90 (2H, m), 5.20 (2H, m), 5.31 (2H, d), 7.19 (2H, dd, J=8.58, 1.8 Hz), 7.47 (2H, t, J=8.22 Hz), 7.63 (2H, m), 7.85 (2H, t, J=7.8 Hz), 7.97 (2H, dd), 8.13 (2H, dd, J=7.68, 2.34 Hz), 8.36 (2H, t) ppm

³¹P-NMR (DMSO-d₆, 243 MHz) δ: 28.89 (s) ppm

### Example 4

### Synthesis of (sulfonylbis(6-oxidodibenzo[c,e][1,2]oxaphosphinine-2,6-diyl))bis(methylene) bis(2-methylacrylate) (DI-DOPO-SF-MA, A4)

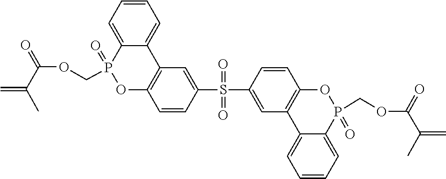 [SMILES: C=C(C)C(=O)OCP1(=O)Oc2ccc(S(=O)(=O)c3ccc4c(c3)-c3ccccc3P(=O)(COC(=O)C(=C)C)O4)cc2-c2ccccc21]

22.3 g of 2,2′-sulfonylbis(6H-dibenzo[c,e][1,2]oxaphosphinine-6-oxide), 80 g of DMAC, and 3 g of polyformaldehyde were mixed in a reaction flask and heated to 70° C.-80° C. and were reacted for 20 hours. After completion of reaction, 80 g of water was added dropwise slowly, and the resulting solid was collected by filtration after cooling to room temperature, washed with water twice and then dried in vacuum, to afford 20.7 g of crude diol intermediate DI-DOPO—SF-FA an off-white solid, which was subjected to the esterification in the next step without further purification.

20.7 g of the crude diol intermediate, 0.47 g of DMAP, 0.038 g of polymerization inhibitor HQ, and 20.7 g of DMF were mixed in a reaction flask and heated to 80° C.-90° C., 14.4 g of methacrylic anhydride was added dropwise slowly, and after the addition is complete, the reaction was performed while maintaining the temperature for 8 hours. Thereafter, the mixture was cooled to room temperature, DMF was recovered under reduced pressure, then the reaction mixture was diluted with 103.5 g of ethyl acetate, and the organic layer was washed with 5% aqueous sodium bicarbonate solution several times. The organic layer was separated, and the solvent was removed at reduced pressure to obtain 17.1 g of product as an off-white solid. The two-step yield was about 55%, and the product was subjected to separation by column chromatography to afford a sample of analytical grade.

³¹P-NMR (DMSO-d₆, 243 MHz) δ: 28.65 (s) ppm

### Example 5

### Synthesis of (6,6′-dioxido-[2,2′-bidibenzo[c,e][1,2]oxaphosphinine]-6,6′-diyl)bis(methylene) bis(2-methylacrylate) (DI-DOPO-MA, A5)

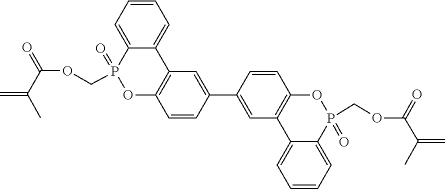 [SMILES: C=C(C)C(=O)OCP1(=O)Oc2ccc(-c3ccc4c(c3)-c3ccccc3P(=O)(COC(=O)C(=C)C)O4)cc2-c2ccccc21]

19.8 g of 2,2′-bis(6H-dibenzo[c,e][1,2]oxaphosphinine-6-oxide), 80 g of DMAC, and 3 g of polyformaldehyde were mixed in a reaction flask and heated to 70° C.-80° C. and were reacted for 20 hours. After completion of reaction, 80 g of water was added dropwise slowly, and the resulting solid was collected by filtration after cooling to room temperature, washed with water twice and then dried in vacuum, to afford 17.9 g of crude diol intermediate DI-DOPO-FA as an off-white solid, which was subjected to the esterification in the next step without further purification.

17.9 g of the crude diol intermediate, 0.46 g of DMAP, 0.037 g of polymerization inhibitor HQ, and 14.1 g of DMF were mixed in a reaction flask and heated to 80° C.-90° C., 14.4 g of methacrylic anhydride was added dropwise slowly, and after the addition is complete, the reaction was performed while maintaining the temperature for 8 hours. Thereafter, the mixture was cooled to room temperature, DMF was recovered under reduced pressure, then the reaction mixture was diluted with 105 g of ethyl acetate, and the organic layer was washed with 5% aqueous sodium bicarbonate solution several times. The organic layer was separated, and the solvent was removed at reduced pressure to obtain 14.4 g of product as an off-white solid. The two-step yield was about 50%, and the product was subjected to separation by column chromatography to afford a sample of analytical grade.

³¹P-NMR (DMSO-d₆, 243 MHz) δ: 28.75 (s) ppm

### Example 6

The example was performed under the conditions according to Example 1, with the alterations of replacing DMAC with an equal amount of chlorobenzene, replacing 1.0 g of DMAP with 15.7 g of pyridine, maintaining the reaction temperature at 5° C.-10° C., and adding 20.7 g of methacryloyl chloride dropwise slowly. Finally, an off-white solid 43.24 g was obtained with a yield of 75%.

### Example 7

The example was performed under the conditions according to Example 2, with the alterations of replacing DMAC with an equal amount of chlorobenzene, replacing 0.5 g of DMAP with 7.8 g of pyridine, maintaining the reaction temperature at 5° C.-10° C., and adding 10.3 g of methacryloyl chloride dropwise slowly. Finally, an off-white solid 20.94 g was obtained with a yield of 72%.

### Example 8

The example was performed under the conditions according to Example 3, with the alterations of replacing DMAC with an equal amount of chlorobenzene, replacing 0.48 g of DMAP with 7.6 g of pyridine, maintaining the reaction temperature at 5° C.-10° C., and adding 10 g of methacryloyl chloride dropwise slowly. Finally, an off-white solid 20.44 g was obtained with a yield of 64%.

### Example 9

The example was performed under the conditions according to Example 4, with the alterations of replacing DMAC with an equal amount of chlorobenzene, replacing 0.47 g of DMAP with 7.4 g of pyridine, maintaining the reaction temperature at 5° C.-10° C., and adding 9.76 g of methacryloyl chloride dropwise slowly. Finally, an off-white solid 20.94 g was obtained with a yield of 72%.

### Example 10

The example was performed under the conditions according to Example 5, with the alterations of replacing DMAC with an equal amount of chlorobenzene, replacing 0.46 g of DMAP with 7.22 g of pyridine, maintaining the reaction temperature at 5° C.-10° C., and adding 9.56 g of methacryloyl chloride dropwise slowly. Finally, an off-white solid 15.26 g was obtained with a yield of 53%.

### Example 11

The example was performed under the conditions according to Example 6, with the alternation of adding 17.9 g of acryloyl chloride dropwise slowly. Finally, an off-white solid 38.5 g was obtained with a yield of 70%.

### Example 12

The example was performed under the conditions according to Example 7, with the alternation of adding 8.9 g of acryloyl chloride dropwise slowly. Finally, an off-white solid 18.8 g was obtained with a yield of 68%.

### Example 13

The example was performed under the conditions according to Example 8, with the alternation of adding 8.7 g of acryloyl chloride dropwise slowly. Finally, an off-white solid 18.3 g was obtained with a yield of 60%.

### Example 14

The example was performed under the conditions according to Example 9, with the alternation of adding 8.45 g of acryloyl chloride dropwise slowly. Finally, an off-white solid 17.2 g was obtained with a yield of 62%.

### Example 15

The example was performed under the conditions according to Example 10, with the alternation of adding 8.3 g of acryloyl chloride dropwise slowly. Finally, an off-white solid 15.1 g was obtained with a yield of 55%.

What is claimed is:

1. A curable phosphorus-containing compound having a bis(6H-dibenzo[c,e][1,2]oxaphosphinine-6-oxide) structure represented by General Formula (1), 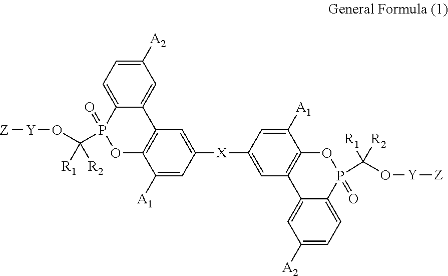
wherein,
A₁ and A₂ are each independently selected from the group consisting of hydrogen atom, hydroxy, cyano, halo, alkoxy, alkyl with a carbon number between 1-8, cycloalkyl with a carbon number between 3-8, aryl, heteroaryl and arylalkyl;
R₁ and R₂ are each independently selected from the group consisting of hydrogen atom, alkyl with a carbon number between 1-8, cycloalkyl with a carbon number between 3-8, aryl, heteroaryl and arylalkyl;
X represents a single bond, (CH₂)ₙ, CR₃R₄, C═O, or SO₂, wherein R₃ and R₄ are respectively selected from the group consisting of hydrogen atom, fluorine atom, fluorine-containing alkyl, alkyl with a carbon number between 1-8, cycloalkyl with a carbon number between 3-8, aryl, heteroalkyl, and arylalkyl, and n is an integer of 1-12;
each Y independently represents 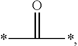
wherein * represents a bonding position; and
each Z independently represents 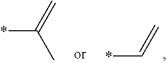
wherein * represents a bonding position.

2. The compound of claim 1, which is selected from at least one of the following:

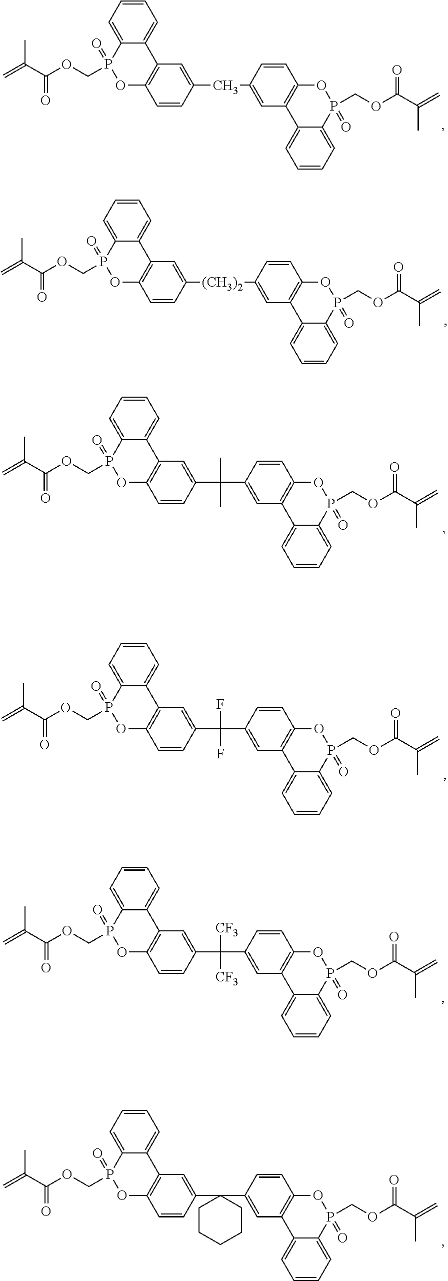

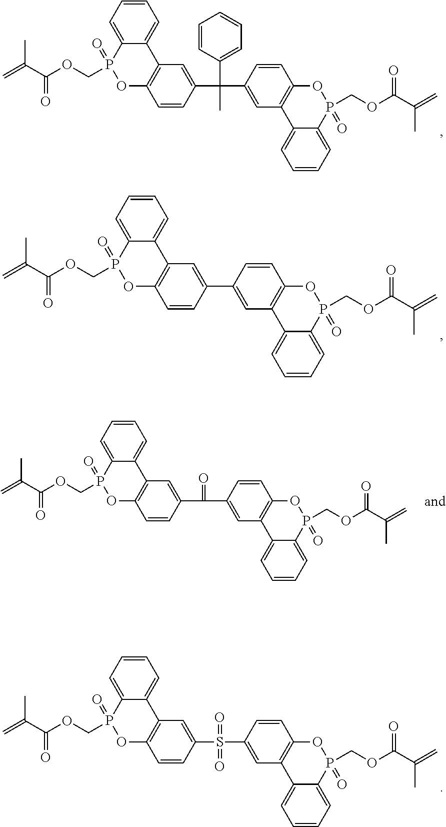

3. The compound of claim 1, which is selected from at least one of the following:

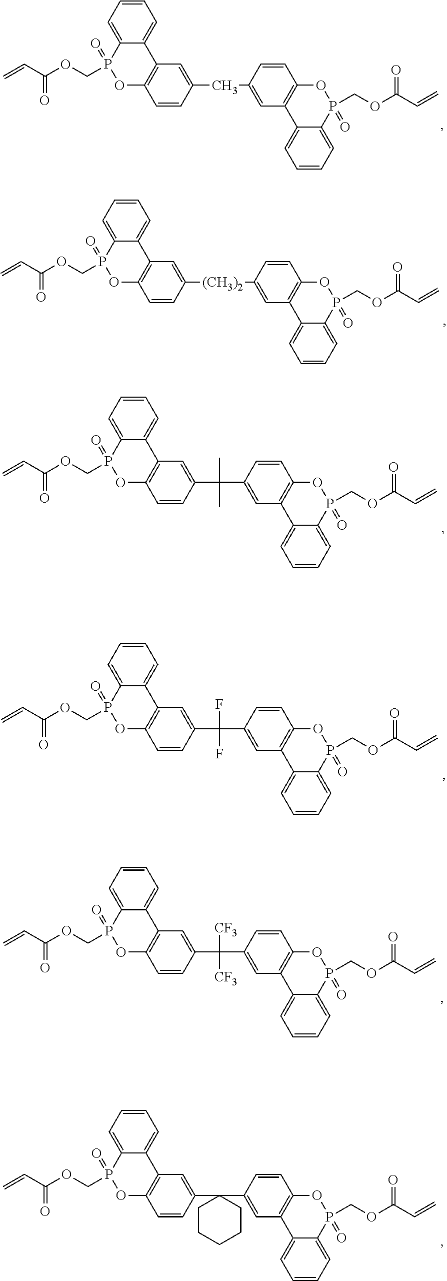

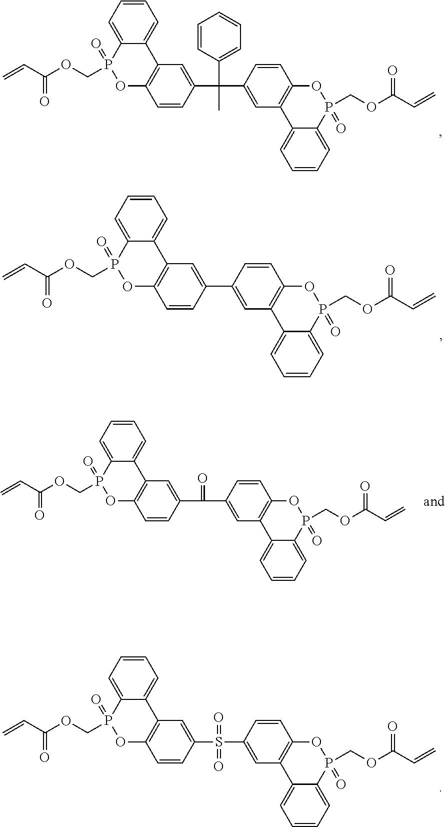

4. A preparation method of a curable phosphorus-containing compound having a bis(6H-dibenzo[c,e][1,2]oxaphosphinine-6-oxide) structure represented by General Formula (1), comprising:
(1) performing a nucleophilic addition reaction of bis(6H-dibenzo[c,e][1,2]oxaphosphinine-6-oxide) with an aldehyde or ketone compound in the presence of a solvent to obtain a diol intermediate; and
(2) performing an esterification reaction of the diol intermediate with an acylating reagent, and a solvent, and optionally a catalyst or an acid-neutralizing agent,
wherein the steps (1) and (2) above are represented by the reaction scheme shown below: 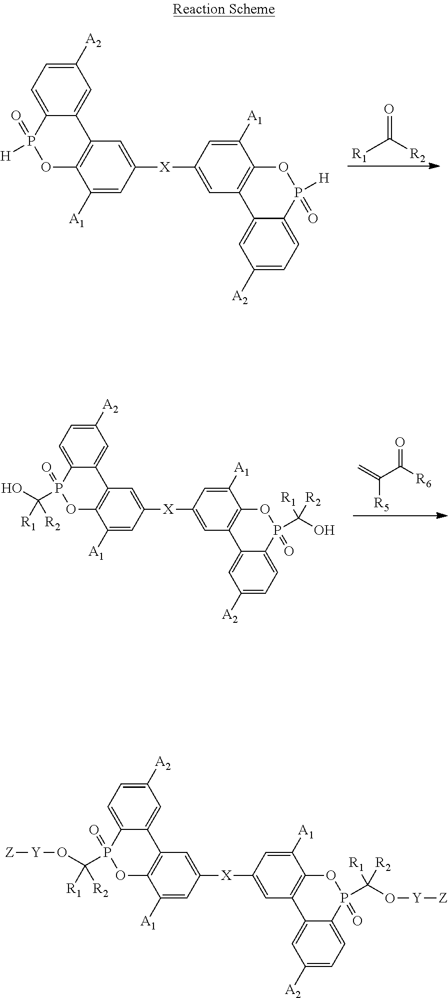
wherein,
A₁ and A₂ are each independently selected from the group consisting of hydrogen atom, hydroxy, cyano, halo, alkoxy, alkyl with a carbon number between 1-8, cycloalkyl with a carbon number between 3-8, aryl, heteroaryl and arylalkyl;
R₁ and R₂ are each independently selected from the group consisting of hydrogen atom, alkyl with a carbon number between 1-8, cycloalkyl with a carbon number between 3-8, aryl, heteroaryl and arylalkyl;
X represents a single bond, (CH₂)ₙ, CR₃R₄, C═O, or SO₂, wherein R₃ and R₄ are respectively selected from the group consisting of hydrogen atom, fluorine atom, fluorine-containing alkyl, alkyl with a carbon number between 1-8, cycloalkyl with a carbon number between 3-8, aryl, heteroalkyl, and arylalkyl, n is an integer of 1-12;
each Y independently represents 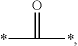
wherein * represents a bonding position;
each Z independently represents 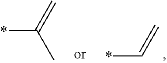
wherein * represents a bonding position;
R₅ represents hydrogen atom or methyl; and
R₆ represents chlorine atom, acryloxy, or methacryloxy.

5. The preparation method of claim 4, wherein in the nucleophilic addition reaction of step (1), an equivalence ratio of the bis(6H-dibenzo[c,e][1,2]oxaphosphinine-6-oxide) to the aldehyde or ketone compound is about 1:2 to about 1:10.

6. The preparation method of claim 4, wherein the nucleophilic addition reaction of step (1) is performed with a mixture comprising the bis(6H-dibenzo[c,e][1,2]oxaphosphinine-6-oxide), the aldehyde or ketone compound, and the solvent at about 20° C. to about 200° C.

7. The preparation method of claim 4, wherein the solvent used in the nucleophilic addition reaction of step (1) is selected from the group consisting of dichloromethane, chloroform, carbon tetrachloride, 1,2-dichloroethane, ethyl acetate, butyl acetate, toluene, xylene, mesitylene, chlorobenzene, dichlorobenzene, trichlorobenzene, N,N′-dimethylformamide, N,N′-dimethylacetamide, N-methylpyrrolidone, dimethyl sulfoxide, and a combination thereof.

8. The preparation method of claim 7, wherein a weight ratio of the solvent to the bis(6H-dibenzo[c,e][1,2]oxaphosphinine-6-oxide) is 1:0.1 to 1:20.

9. The preparation method of claim 4, wherein in the esterification reaction of step (2), an equivalence ratio of the diol intermediate to the acylating reagent is about 1:2 to about 1:10.

10. The preparation method of claim 4, wherein the esterification reaction of step (2) is performed with a mixture comprising the diol intermediate and the acylating reagent, and the solvent, and optionally the catalyst or the acid-neutralizing agent at about −20° C. to about 150° C.

11. The preparation method of claim 4, wherein the catalyst or the acid-neutralizing agent used in the esterification reaction of step (2) is selected from the group consisting of lithium hydroxide, sodium hydroxide, potassium hydroxide, magnesium hydroxide, calcium hydroxide, lithium carbonate, lithium bicarbonate, sodium carbonate, sodium bicarbonate, potassium carbonate, potassium bicarbonate, ammonia, dimethylamine, diethylamine, di-n-propylamine, di-isopropylamine, di-n-butylamine, di-isobutylamine, triethylamine, tri-n-propylamine, tri-n-butylamine, 1,4-diazabicyclo[2.2.2]octane (DABCO), pyridine, 2-methylpyridine, 4-methylpyridine, 2,6-dimethylpyridine, 4-N,N′-dimethylpyridine (DMAP), and a combination thereof.

12. The preparation method of claim 11, wherein the catalyst or the acid-neutralizing agent may be absent; if present, a weight ratio of the catalyst or the acid-neutralizing agent to the diol intermediate is 0:0.1 to 5:1.

13. The preparation method of claim 4, wherein the solvent used in the esterification reaction of step (2) is selected from the group consisting of dichloromethane, chloroform, carbon tetrachloride, 1,2-dichloroethane, ethyl acetate, butyl acetate, toluene, xylene, mesitylene, chlorobenzene, dichlorobenzene, trichlorobenzene, N,N′-dimethylformamide, N,N′-dimethylacetamide, N-methylpyrrolidone, dimethyl sulfoxide, and a combination thereof.

14. The preparation method of claim 13, wherein a weight ratio of the solvent to the bis(6H-dibenzo[c,e][1,2]oxaphosphinine-6-oxide) is 1:0.1 to 0.
